(19) United States
(12) Patent Application Publication
(10) Pub. No.: US 2019/0188829 A1
(43) Pub. Date: Jun. 20, 2019

(54) Method, Apparatus, and Circuitry of Noise Reduction

(71) Applicant: MultiTek Inc., Hsinchu City (TW)

(72) Inventor: Ku-Chu Wei, New Taipei City (TW)

(21) Appl. No.: 15/842,762

(22) Filed: Dec. 14, 2017

(51) Int. Cl. G06T 5/00; H04N 19/56; H04N 19/55; H04N 19/573; H04N 19/117; H04N 19/615

(52) U.S. Cl. CPC G06T 5/002; H04N 19/56; H04N 19/55; G06T 2207/20182; H04N 19/117; H04N 19/615; H04N 19/573

(57) ABSTRACT

A method of noise reduction is discloses. The method comprises identifying a plurality of candidate matching blocks in a reference frame for a current patch; obtaining at least one filtering result based on the plurality of candidate matching blocks; determining at least one reference block from a plurality of candidate motion vectors; and generating a de-noised patch for the current patch according to the at least one filtering result and the at least one reference block.

### BACKGROUND OF THE INVENTION

### 1. Field of the Invention

The present invention relates to a method, an apparatus and a circuitry of noise reduction, and more particularly, to a method and a computing system of exploiting spatial and temporal information to reduce noise in images.

### 2. Description of the Prior Art

With the development of the technology, all kinds of digital cameras are provided. The demand of digital image processing technology for industry and consumers increases. In a conventional system, spatial noise reduction (NR), i.e. two-dimensional (2D) NR is mainly utilized for processing still images and exploits spatial information of frames to reduce noises in images by edge-preserving filters, and so on. Temporal noise reduction, i.e. three-dimensional (3D) NR, is mainly utilized for processing videos and exploits temporal information to reduce noises in videos by motion adaptive noise reduction (MANR) and motion compensation noise reduction (MCNR) and so on. However, 2D NR and 3D NR are usually deployed separately to reduce noise for images and videos, which increases complexity and costs in a system to perform 2D NR and 3D NR simultaneously.

Therefore, how to exploit both spatial information and temporal information to reduce noises in images and videos has become an important topic.

### SUMMARY OF THE INVENTION

It is therefore an object of the present invention to provide a method, apparatus and a circuitry of exploiting both spatial and temporal consistency to reduce noise in images and video so as to improve the disadvantages of the prior art.

An embodiment of the present invention discloses a method of noise reduction, comprising identifying a plurality of candidate matching blocks in a reference frame for a current patch; obtaining at least one filtering result based on the plurality of candidate matching blocks; determining at least one reference block from a plurality of candidate motion vectors; and generating a de-noised patch for the current patch according to the at least one filtering result and the at least one reference block.

An embodiment of the present invention further discloses an apparatus for noise reduction, comprising a motion estimation unit, for identifying a plurality of candidate matching blocks in a reference frame for a current patch; a filtering unit, for obtaining at least one filtering result based on the plurality of candidate matching blocks; a compensation unit, for determining at least one reference block from a plurality of candidate motion vectors; and a noise reduction unit, for generating a de-noised patch for the current patch according to the at least one filtering result and the at least one reference block.

An embodiment of the present invention further discloses an circuitry for noise reduction, comprising a motion estimation circuit, for identifying a plurality of candidate matching blocks in a reference frame for a current patch; a filter circuit, coupled to the motion estimation circuit, for obtaining at least one filtering result based on the plurality of candidate matching blocks; a motion compensation circuit, coupled to the motion estimation circuit, for determining at least one reference block from a plurality of candidate motion vectors; and a noise reduction circuit, coupled to the motion estimation circuit and the motion compensation circuit, for generating a de-noised patch for the current patch according to the at least one filtering result and the at least one reference block.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a schematic diagram of a noise reduction process according to an embodiment of the present invention.

FIG. 2 is a schematic diagram of a current frame with a plurality of current patches.

FIG. 3 is a schematic diagram of a motion estimation according to an embodiment of the present invention.

FIG. 4 is a schematic diagram of a motion compensation according to an embodiment of the present invention.

FIG. 5 is a schematic of a unified noise reduction according to an embodiment of the present invention.

FIG. 6 is a schematic diagram of an apparatus according to an embodiment of the present invention.

FIG. 7 is a schematic diagram of a circuitry according to an example of the present invention.

### DETAILED DESCRIPTION

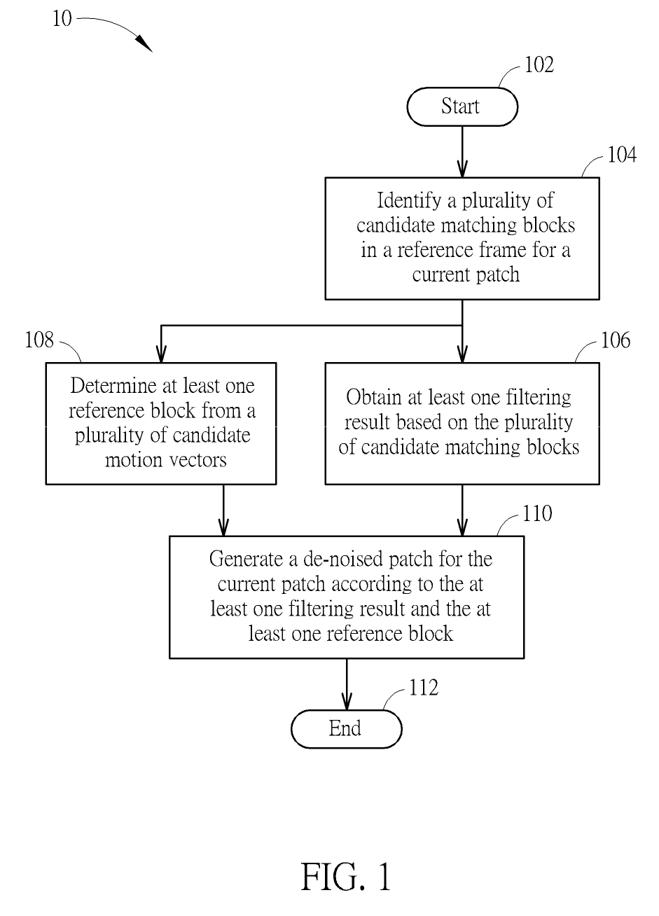

Please refer to FIG. 1, which is a schematic diagram of a noise reduction process 10 according to an embodiment of the present invention. The noise reduction process 10 includes the following steps:

Step 102: Start.

Step 104: Identify a plurality of candidate matching blocks in a reference frame for a current patch.

Step 106: Obtain at least one filtering result based on the plurality of candidate matching blocks.

Step 108: Determine at least one reference block from a plurality of candidate motion vectors.

Step 110: Generate a de-noised patch for the current patch according to the at least one filtering result and the at least one reference block.

Step 112: End.

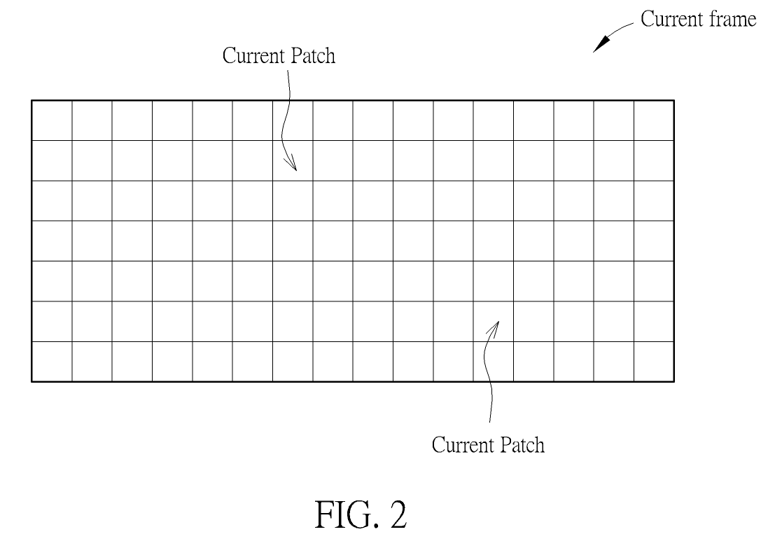

To explain the noise reduction process 10, please further refer to FIG. 2. As shown in FIG. 2, a current frame of images or videos is divided to a plurality of current patches, which are not overlapped with each other, and a current patch has a size of 1*1 to M*N. Note that, the current patch is a pixel when the size of the current patch is 1*1. Then, the noise reduction process 10 is utilized to determine the de-noised patch accordingly for each of the patches of the current frame.

In step 104, the candidate matching blocks are identified from the current patch and the reference frame, wherein the reference frame may be the current frame or one of a plurality of frames captured by an identical capturing device or in an identical video source, or the reference frame is generated by different capturing device or in different video sequence. In this embodiment, a motion estimation is utilized to identify the candidate matching blocks and the corresponding candidate motion vectors by at least one search region. That is, the motion estimation determines the candidate motion vectors that describe the transformation from the reference frame to the current patch in the current frame, which exploits intermediate information for temporal consistency across different frames. In an embodiment, the candidate motion vector may be determined by the current frame at time t and a previous frame at time t−1 or the current frame itself.

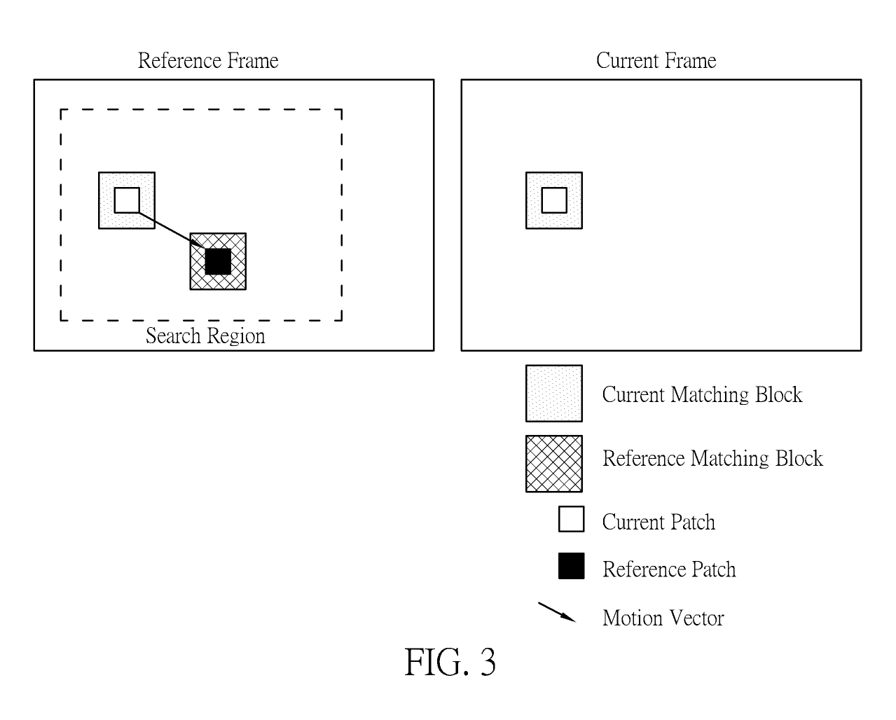

Please further refer to the FIG. 3, which is a schematic diagram of the motion estimation according to an embodiment of the present invention. A candidate motion vector is determined in a search region of the reference frame with the current patch and a reference patch. As shown in FIG. 3, a size of a current matching block is equal to or greater than the current patch, and a size of a reference matching block is equal to or greater than the reference patch, and a size or a shape of the search region may be arbitrary, and not limited thereto. For example, as shown in FIG. 3, the search region includes the current matching block and the reference matching block, wherein the reference matching block further includes the reference patch, and the current matching block includes the current patch. The candidate motion vector is determined by the current matching block and the reference matching block in order to acquire a motion between the current patch and the reference patch. Therefore, the candidate motion vectors are determined by searching nearby patches (or blocks) of the current patch of self-similarity when performing the motion estimation. Note that, the current matching block and the reference matching block may be overlapped with each other.

Take the temporal noise reduction (i.e. 3D NR) for example. The candidate motion vector of the current patch in the current frame is determined by the current patch and the reference patch. Then, the temporal NR collects temporal information (i.e. the current and reference blocks/patches) by finding the candidate motion vector in the search region, and the determined candidate motion vector has a lowest patch cost within the search region, wherein the patch cost is determined by at least one of a matching cost, a mean absolute difference (MAD), a sum of square difference (SSD) and a sum of absolute difference (SAD) or any other indexes by weighting functions, which exploits a spatial continuity or temporal continuity of the adjacent candidate motion vectors, and not limited thereto.

Take the spatial noise reduction (i.e. 2D NR) as another example. The candidate matching blocks with patch costs and candidate motion vectors are respectively determined by the motion estimation, which exploits self-similarity by searching nearby patches, wherein each of the candidate matching blocks has the lowest patch cost. That is, the spatial NR collects similar matching blocks in the search regions, which are shared with temporal NR, according to the current patch and the reference frame. In an embodiment, the candidate matching blocks, the corresponding candidate motion vectors and patch costs maybe stored in an accumulator or a buffer (not shown in the figures), for buffering spatial information, and not limited thereto.

After generating the candidate matching blocks and the candidate motion vectors according to the current patch and the reference frame, in step 106, at least one filtering result is obtained by filtering according to the candidate matching blocks, the patch costs and the candidate motion vectors, wherein the filtering result has a corresponding filtering score S_{f}.

In an embodiment, when the reference frame is a previous frame of the current frame, the one or more filtering results determined in step 106 exploit the spatial information and the temporal information to reduce noise. In another embodiment, when the reference frame is the current frame, the one or more filtering results determined in step 106 exploit the spatial self-similarity to reduce noise. In another embodiment, when the reference frame is generated by different capturing device or in different video sequence, the one or more filtering results determined in step 106 exploit a texture similarity to synthesize a noise-free result for the current patch.

On the other hand, for the temporal NR, in step 108, a current block and a reference block are accordingly determined from the candidate motion vectors. In this embodiment, a motion compensation is utilized to generate the current block and the reference block for each current patch of the current frame.

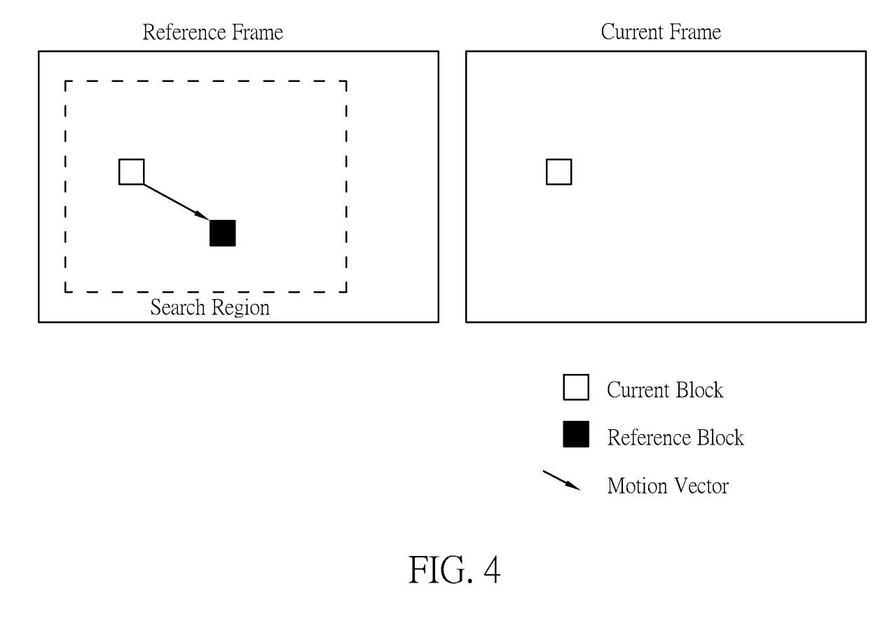

In details, please refer to the FIG. 4, which is a schematic diagram of the motion compensation according to an embodiment of the present invention. As shown in FIG. 4, according to the candidate motion vectors determined in step 104, the current block and the reference block in the reference frame are determined to count the motion, wherein the noise reduction only relates to a size of the current block and a size of the reference block, but is independent to the size of the patch and the size of the matching block. In other words, for the temporal NR, the current block and the reference block remain the same when the size of the patch and the size of the matching block are different. Therefore, the temporal NR utilizes the candidate motion vector, generated by the motion estimation in step 104, to determine the current block and the reference block, which are related to the motion of the current frame.

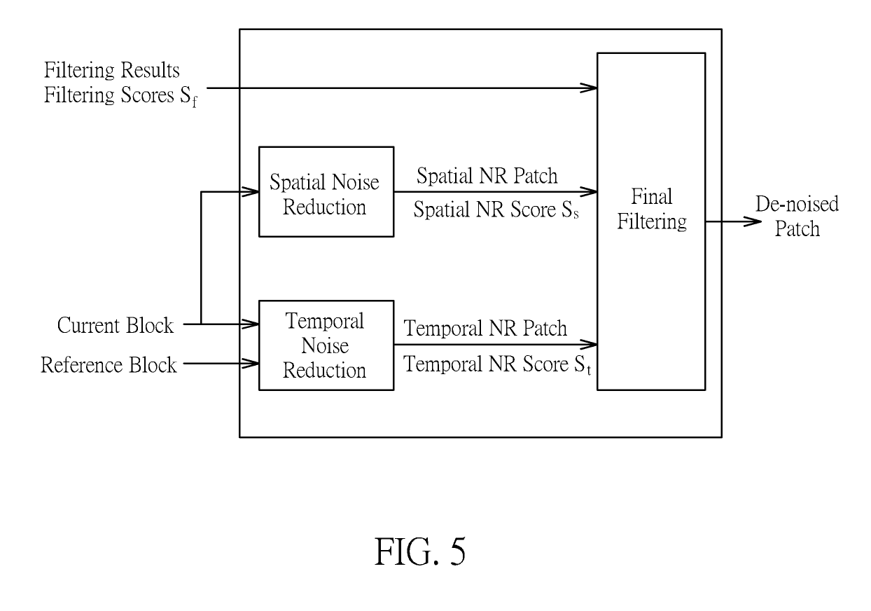

In step 110, the de-noised patch is generated according to the filtering results and the reference block. Please refer to FIG. 5, which is a schematic of a unified noise reduction according to an embodiment of the present invention. In this embodiment, for the spatial NR, the current blocks are utilized to generate a spatial noise reduction patch with a spatial noise reduction score Sₛ accordingly fora final filtering. In another embodiment, the spatial NR may need a buffer (not shown in the figures) for buffering the spatial blocks for an advanced spatial NR. In addition, for the temporal NR, a temporal noise reduction patch with a temporal noise reduction score Sₜ are generated according to the current block and the reference block. Therefore, the filtering results with filtering scores S_{f} determined in step 106, the determined spatial noise reduction patch with a spatial noise reduction score Sₛ and the temporal noise reduction patch with a temporal noise reduction score Sₜ are filtered to generate the de-noised patch, wherein a plurality of de-noised patches, determined by the noise reduction process 10, may further compose a de-noised frame with the temporal or spatial noise reduction.

To be more specifically, for each of the candidate matching block with corresponding patch costs and motion vectors, the spatial noise reduction checks whether the patch cost is lower than a threshold, if yes, adds the candidate matching block to a block set. After all of the candidate matching blocks are processed, the block set is applied to generate the spatial noise reduction patch with the spatial noise reduction score Sₛ. Notably, the threshold maybe a pre-defined hard threshold or a soft threshold according to a statistics of the current block, such as, a mean or a variance, and not limited herein. In addition, a non-linear weighted average filtering may be implemented to determine the de-noised patch according to the spatial noise reduction score Sₛ and the temporal noise reduction score Sₜ.

Notably, the embodiments stated above illustrates the concept of the present invention, those skilled in the art may make proper modifications accordingly, and not limited thereto. For example, the noise reduction process 10 maybe rearranged, for example, the motion search and the accumulator may be implemented in the motion estimation, the predictor and the motion vector field may be implemented in the motion estimation, and not limited to the steps stated above.

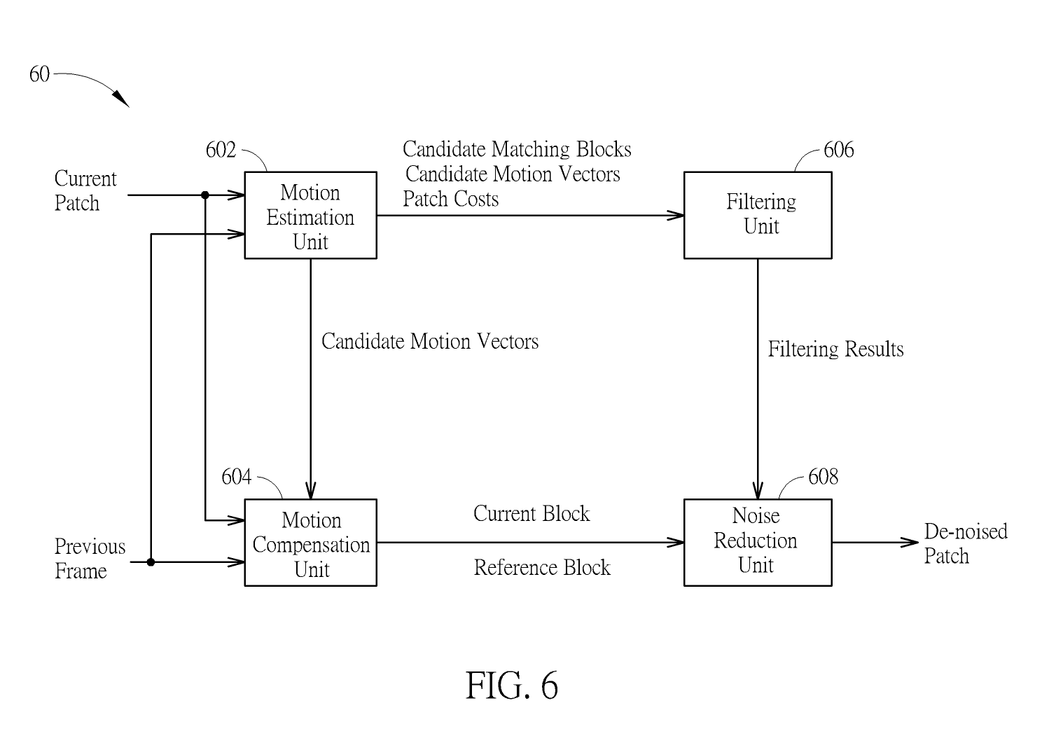

Please refer to FIG. 6, which is a schematic diagram of an apparatus 60 according to an example of the present invention. The apparatus 60 includes a motion estimation unit 602, a motion compensation unit 604, a filtering unit 606 and a noise reduction unit 608, which may be utilized for respectively realizing the motion estimation, motion compensation, filtering and final filtering stated above, so as to generate a de-noised patch, and is not limited herein.

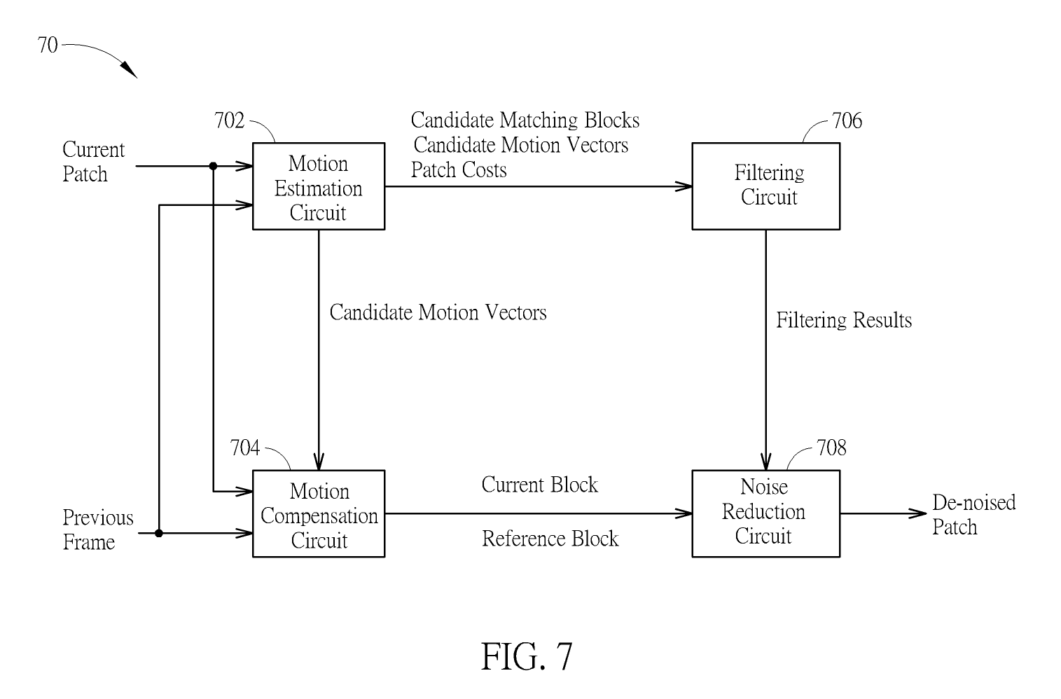

Moreover, please refer to FIG. 7, which is a schematic diagram of a circuitry 70 according to an example of the present invention. The circuitry 70 includes a motion estimation circuit 702, a motion compensation circuit 704, a filtering circuit 706 and a noise reduction circuit 708, which may be utilized for respectively realizing the motion estimation, motion compensation, filtering and final filtering stated above, so as to generate a de-noised patch, but is not limited herein. The circuitry 70 may be implemented by a microprocessor or Application Specific Integrated Circuit (ASIC), and not limited thereto.

In summary, the noise reduction method of the present invention exploits spatial and temporal information to reduce noise in the spatial (i.e. 2D) and the temporal (i.e. 3D) NR simultaneously, and thereby reducing the noise of images or videos and improving quality of images or videos.

Those skilled in the art will readily observe that numerous modifications and alterations of the device and method may be made while retaining the teachings of the invention. Accordingly, the above disclosure should be construed as limited only by the metes and bounds of the appended claims.

1. A method of noise reduction, comprising:
identifying a plurality of candidate matching blocks in a reference frame for a current patch;
obtaining at least one filtering result based on a plurality of pixels of the plurality of candidate matching blocks;
determining at least one reference block from a plurality of candidate motion vectors; and
generating a de-noised patch for the current patch according to the at least one filtering result, a spatial noise reduction patch and a temporal noise reduction patch;
wherein the spatial noise reduction patch is with a spatial noise reduction score and the temporal noise reduction patch is with a temporal noise reduction score.

2. The method of claim 1, wherein the plurality of candidate matching blocks comprise a plurality of patch costs and the plurality of candidate motion vectors respectively corresponding to the plurality of candidate matching blocks.

3. The method of claim 2, wherein the patch cost is determined by at least one of a matching cost, a mean absolute difference (MAD), a sum of square difference (SSD) and a sum of absolute difference (SAD).

4. The method of claim 2, wherein the plurality of candidate motion vectors are determined by a reference patch in a search region of the reference frame and the current patch.

5. The method of claim 4, wherein each filtering result is generated based on the at least one candidate matching block and at least one current matching block, wherein the at least one current matching block is generated based on the plurality of patch costs and the plurality of candidate motion vectors.

6. The method of claim 4, wherein a size or a shape of the search region is arbitrary.

7. The method of claim 4, wherein each filtering result is generated based on the at least one candidate matching block, the plurality of patch costs and the plurality of candidate motion vectors.

8. The method of claim 4, wherein the reference patch is in a reference matching block and the current patch is in a current matching block, a size of the reference matching block is equal to or greater than the reference patch, and a size of the current matching block is equal to or greater than the current patch.

9. The method of claim 8, wherein the reference matching block and the current matching block are utilized for determining the plurality of candidate motion vectors.

10. The method of claim 1, wherein the reference frame is a current frame relative to the current patch and the current patch is generated by an identical capturing device or in an identical video sequence.

11. The method of claim 1, wherein the reference frame is a current frame relative to the current patch and the current patch is generated by different capturing device or in different video sequence.

12. An apparatus for noise reduction, comprising:
a motion estimation unit, for identifying a plurality of candidate matching blocks in a reference frame for a current patch;
a filtering unit, for obtaining at least one filtering result based on a plurality of pixels of the plurality of candidate matching blocks;
a compensation unit, for determining at least one reference block from a plurality of candidate motion vectors; and
a noise reduction unit, for generating a de-noised patch for the current patch according to the at least one filtering result, a spatial noise reduction patch and a temporal noise reduction patch;
wherein the spatial noise reduction patch is with a spatial noise reduction score and the temporal noise reduction patch is with a temporal noise reduction score.

13. The apparatus of claim 12, wherein the plurality of candidate matching blocks comprise a plurality of patch costs and the plurality of candidate motion vectors respectively corresponding to the plurality of candidate matching blocks.

14. The apparatus of claim 13, wherein the patch cost is determined by at least one of a matching cost, a mean absolute difference (MAD), a sum of square difference (SSD) and a sum of absolute difference (SAD).

15. The apparatus of claim 13, wherein the plurality of candidate motion vectors are determined by a reference patch in a search region of the reference frame and the current patch.

16. The apparatus of claim 15, wherein each filtering result is generated based on the at least one candidate matching block and at least one current matching block, wherein the at least one current matching block is generated based on the plurality of patch costs and the plurality of candidate motion vectors.

17. The apparatus of claim 15, wherein a size or a shape of the search region is arbitrary.

18. The apparatus of claim 15, wherein each filtering result is generated based on the at least one candidate matching block, the plurality of patch costs and the plurality of candidate motion vectors.

19. The apparatus of claim 15, wherein the reference patch is in a reference matching block and the current patch is in a current matching block, a size of the reference matching block is equal to or greater than the reference patch, and a size of the current matching block is equal to or greater than the current patch.

20. The apparatus of claim 19, wherein the reference matching block and the current matching block are utilized for determining the plurality of candidate motion vectors.

21. The apparatus of claim 12, wherein the reference frame is a current frame relative to the current patch and the current patch is generated by an identical capturing device or in an identical video sequence.

22. The apparatus of claim 12, wherein the reference frame is a current frame relative to the current patch and the current patch is generated by different capturing device or in different video sequence.

23. A circuitry for noise reduction, comprising:
a motion estimation circuit, for identifying a plurality of candidate matching blocks in a reference frame for a current patch;
a filter circuit, coupled to the motion estimation circuit, for obtaining at least one filtering result based on a plurality of pixels of the plurality of candidate matching blocks;
a motion compensation circuit, coupled to the motion estimation circuit, for determining at least one reference block from a plurality of candidate motion vectors; and
a noise reduction circuit, coupled to the motion estimation circuit and the motion compensation circuit, for generating a de-noised patch for the current patch according to the at least one filtering result, a spatial noise reduction patch and a temporal noise reduction patch;
wherein the spatial noise reduction patch is with a spatial noise reduction score and the temporal noise reduction patch is with a temporal noise reduction score.

24. The circuitry of claim 23, wherein the plurality of candidate matching blocks comprise a plurality of patch costs and the plurality of candidate motion vectors respectively corresponding to the plurality of candidate matching blocks.

25. The circuitry of claim 24, wherein the patch cost is determined by at least one of a matching cost, a mean absolute difference (MAD), a sum of square difference (SSD) and a sum of absolute difference (SAD).

26. The circuitry of claim 24, wherein the plurality of candidate motion vectors are determined by a reference patch in a search region of the reference frame and the current patch.

27. The circuitry of claim 26, wherein each filtering result is generated based on the at least one candidate matching block and at least one current matching block, wherein the at least one current matching block is generated based on the plurality of patch costs and the plurality of candidate motion vectors.

28. The circuitry of claim 26, wherein a size or a shape of the search region is arbitrary.

29. The circuitry of claim 26, wherein each filtering result is generated based on the at least one candidate matching block, the plurality of patch costs and the plurality of candidate motion vectors.

30. The circuitry of claim 26, wherein the reference patch is in a reference matching block and the current patch is in a current matching block, a size of the reference matching block is equal to or greater than the reference patch, and a size of the current matching block is equal to or greater than the current patch.

31. The circuitry of claim 30, wherein the reference matching block and the current matching block are utilized for determining the plurality of candidate motion vectors.

32. The circuitry of claim 23, wherein the reference frame is a current frame relative to the current patch and the current patch is generated by an identical capturing device or in an identical video sequence.

33. The circuitry of claim 23, wherein the reference frame is a current frame relative to the current patch and the current patch is generated by different capturing device or in different video sequence.
